(19) United States
(12) Patent Application Publication
(10) Pub. No.: US 2013/0030865 A1
(43) Pub. Date: Jan. 31, 2013

(54) METHOD OF CONSTRUCTING A LOYALTY GRAPH

(71) Applicants: Jose-Miguel Pulido Villaverde, Barcelona (ES); Miquel Sonsona Villalobos, Torredembarra, (ES); Diego Campo Millan, Zaragoza (ES); Jens Grivolla, Barcelona (ES); Toni Badia, Barcelona (ES); David Maso Mas, Seva (ES); Adria Carulla Ruiz, Barcelona (ES)

(72) Inventors: Jose-Miguel Pulido Villaverde, Barcelona (ES); Miquel Sonsona Villalobos, Torredembarra, (ES); Diego Campo Millan, Zaragoza (ES); Jens Grivolla, Barcelona (ES); Toni Badia, Barcelona (ES); David Maso Mas, Seva (ES); Adria Carulla Ruiz, Barcelona (ES)

(73) Assignee: NOVA-VENTUS CONSULTING SL, Barcelona (ES)

(21) Appl. No.: 13/553,001

(22) Filed: Jul. 19, 2012

Related U.S. Application Data
(60) Provisional application No. 61/511,209, filed on Jul. 25, 2011.

(51) Int. Cl. G06Q 30/02

(52) U.S. Cl. 705/7.29

(57) ABSTRACT

Offers for goods or services are targeted more efficiently to potential consumers by using a loyalty graph having nodes that correspond to users and edges that correspond to relationships between the users. The offers are transmitted to only superusers, corresponding to supernodes in the loyalty graph. By targeting only the superusers, the number of invitations transmitted as part of the promotion is reduced. The superusers are determined by calculating a weighted score for each node. Each weighted score corresponds to a number of directed connections between a node and its leaf nodes, with the supernodes determined as the subset of nodes having a weighted sum above a pre-determined threshold. After identifying superusers, subgraphs can be generated corresponding to each superuser. The subgraphs can be selected according to different criteria. In this way, promotions can be targeted to superusers in only selected subgraphs or to all the users in selected subgraphs.

### RELATED APPLICATION

This application claims priority under 35 U.S.C. §119(e) of the co-pending U.S. provisional patent application Ser. No. 61/511,209, filed Jul. 25, 2011, and titled “Loyalty Graph,” which is hereby incorporated by reference.

### FIELD OF THE INVENTION

This invention is related to electronic commerce. More particularly, this invention is related to efficiently promoting products and services using loyalty graphs.

### BACKGROUND OF THE INVENTION

With the advent of social networks such as Facebook®, personal and professional relationships between users are being developed online. These online relationships usually reflect offline relationships between users that are replicated online within the framework of Web sites that promote the construction of the users' social graph, such as Facebook®. The social graph and the related sites are especially useful to enable these personal relationships to continue online when there are significant temporal and spatial barriers that would prevent them from continuing offline. For example, sites such as Facebook® are notorious for enabling classmates to reencounter each other after many years apart, or for allowing old friends, now living far apart, to keep in touch. In addition, professional relationships can also be established between society leaders such as sports players, entrepreneurs, artists, and their followers, enabling a direct communication line that would otherwise be difficult to establish.

Another type of relationship is also captured in social networks, those between users and entities such as brands and products. These relationships usually reflect the tastes and preferences of the users, and also reflect the existence of such relationships offline, such as whether the user usually purchases a given product. These types of commercial relationships have a different nature than the personal and professional ones, because users often do not have a strong incentive to establish them, as opposed to having a relationship with an old friend, or following a star of their favorite football team, for which users are willing to take the steps to establish.

In contrast, brands in general, and those brands that do not have control on the point of sale because their products are sold through third party distribution channels in particular, are eager to develop these relationships with their existing and potential customers, because they are usually blind to them, due to not having direct contact with them. Furthermore, third party distributors that do have direct access to the brands' customers consider this type of information as strategic, and are usually not willing to share it with the brands. On the contrary, it is common for distributors to leverage the knowledge of this information in their negotiation with the brands.

Therefore, brands know that they need to create incentives for users if they want users to establish online relationships with the brands. These incentives can either be short term and independent of each other, such as offering users promotions and discounts, or as part of a loyalty program designed to establish a longer term relationship with users and reward such loyalty. In addition, gaming techniques based on challenges and rewards, such as those used in Scvngr™ and Foursquare®, are usually taken into consideration to make it “more fun” for users to participate.

When marketing services and products, finding and rewarding best marketers (i.e., those users of a brand that best promote their products) becomes an important component of an online loyalty program, and creating the so-called loyalty graph is the mechanism to do it. Kempe et al., Maximizing the Spread of Influence Through a Social Network, Proceedings of the Ninth ACM SIGKDD (2003) 137-146, sought to determine the subset of individuals that should be initially targeted in a viral marketing campaign to maximize the cascade of further adoptions triggered by that initial subset. They confirmed that an algorithm to determine the initial subset is NP-hard, and they provided a heuristic that is probably within 63% of optimal solutions.

Their work is a theoretical one. It assumes the existence of a directed graph, and that the tendency of a node to participate in a promotion increases monotonically as more of its neighbors become active. Each edge in the graph has a weight reflecting the influence of the neighbor, and the aggregate weight of incoming edges from active neighbors is compared against a threshold to determine if a node becomes active or not.

Aral et al., Creating Social Contagion through Viral Product Design: A Randomized Trial of Peer Influence in Networks, Social Science Research Networking Paper Series (30 May 2010), compared the effect of active, targeted invitations with passive, massive invitations, using a Facebook® application. Their results indicated that targeted invitations were only slightly better than passive invitations, and they reasoned that even though active, targeted invitations had a higher rate of success than passive invitations, the effort required for active invitations made them less common, and that the massive nature of passive invitations compensated its lower rate of success.

### SUMMARY OF THE INVENTION

In accordance with the invention, one or more subgraphs are generated from a loyalty graph having nodes that correspond to users. The subgraphs are used to determine “supernodes,” which correspond to “superusers,” the best promoters of products and services. Best promoters can be determined in a variety of ways, such as by calculating a metric indicating how many coupons that a user transmits actually results in the purchase of a good or service. Other methods can be used to measure a user's influence within a group.

The generation of subgraphs, the identification of superusers, or both can be used in many ways. As one example, brands rank the best promoters of their products and services using a metric to determine the best promoters. Targeting these best promoters with future promotions, rather than all potential customers of a product, reduces Internet traffic and minimizes email spam. Targeting these promoters also increases the likelihood that actual customers receive the promotion since they will not be “missed” by a viral campaign that might not know of their existence. By tracking user patterns, brands can track good marketers across products and tailor future promotions accordingly, becoming less dependent on third-party advertisers to learn the results of promotions.

In accordance with the invention, a first loyalty graph is used to generate one or more subgraphs. The first loyalty graph has multiple nodes connected by multiple edges, each of the multiple edges is assigned one or more states, and the multiple nodes include leaf nodes corresponding to one of the one or more states. The loyalty graph is pruned according to each of the states, thereby generating a plurality of one or more subgraphs, each reflecting relationships between nodes having edges in a given state. For each of the one or more subgraphs, a weighted score is determined for each node. For each of the one or more subgraphs, one or more supernodes are determined as a subset of nodes having a weighted score above a first pre-determined threshold. In one embodiment, the leaf nodes correspond to a user purchasing a good or service, a user having accessed a coupon for a good or service, or a user having accepted an invitation to join a group to receive a good or service. In one embodiment, offers for goods or services are transmitted to only the supernodes from among the multiple nodes.

In one embodiment, for each of the one or more subgraphs, offers for goods or services are transmitted to only the supernodes of the subgraph from among multiple nodes in the subgraph. In another embodiment, offers for goods or services are transmitted to only the nodes in selected one or more subgraphs from among the multiple nodes in the loyalty graph. In yet another embodiment, nodes having edges in a same state are identified for later use.

In one embodiment, the loyalty graph is pruned by pruning nodes that are not supernodes. In one embodiment, each of the weighted scores is adjusted by a corresponding reliability measure.

In one embodiment, the weighted scores are combined with weighted scores for a second loyalty graph to determine a set of combined weighted scores. Scores in the combined set of weighted scores are compared to a second pre-determined threshold to determine a second set of supernodes. In this way, supernodes can be calculated using information from multiple promotions for related products or services, targeted for later promotions.

### BRIEF DESCRIPTION OF THE DRAWINGS

The following figures are used to illustrate embodiments of the invention. In all the figures, the same label refers to the identical or a similar element.

FIG. 1 shows a social graph of a single inviter, with both direct and indirect friends.

FIG. 2 shows a loyalty graph of a single inviter, where edges between the inviter and the invitee are marked with the “accepted state,” in accordance with embodiments of the invention, indicating that the invitee has accepted an invitation.

FIG. 3 shows a loyalty graph of a single inviter, where edges between the inviter and the invitee are also marked with a “distributed state,” in accordance with embodiments of the invention, indicating that an invitee has accessed a coupon of the promotion.

FIG. 4 shows a loyalty graph of a single inviter, where edges between the inviter and the invitee are also marked with the “validated state,” in accordance with embodiments of the invention,” indicating that an invitee has used the coupon of the promotion.

FIG. 5 shows a loyalty graph that has been pruned to include only those nodes having edges in a “validated” state.

FIG. 6 shows a loyalty graph that has been pruned to include only those nodes having edges in a “distributed” state.

FIG. 7 is a flow chart of the steps for creating a loyalty graph in accordance with one embodiment of the invention.

FIG. 8 shows a loyalty graph resulting from multiple inviters and invitees, including disjointed subgraphs, in accordance with the invention.

FIG. 9 is a diagram showing a system for generating and using a loyalty graph in accordance with the invention.

### DETAILED DESCRIPTION OF THE PREFERRED EMBODIMENTS

Loyalty programs are used to discover and reward the most valuable customers, usually defined as those customers that spend more money over a period of time. Loyalty programs take into account full-price purchases made by customers, and customers get rewards proportional to the amount of money they spend. In addition, customers can access rewards by performing additional actions, such as inviting friends, and promoting products among their relationships.

With the advent of social networks, the success of promoting products among relationships, for example, relationships relating to the user's online social networks, can suddenly be quantified. This is significant because it enables brands to discover their best marketers through their loyalty programs. That is, they can now discover which users generate the most revenue when promoting products through their social networks. These “best marketers” are not necessarily the highest spenders but perhaps are more important to brands because they are the ones generating the largest amount of revenue through their network of relationships. Best marketers can be different not only among different brands, but also across different products from the same brand.

Best marketers are thus defined as those consumers that generate the largest amount of business, not necessarily through their own individual purchases, but also through the purchases of additional customers actively engaged by the best marketers by using their own social graph as a vehicle for promoting the brands' products.

In contrast to the work of Kempe et al., in accordance with the principles of the invention, an existing graph is analyzed, the best marketers in the graph are deterministically identified in the context of a given brand and product, and the best marketers are reused in similar contexts.

Preferably, passive targeting (e.g., broadcasting to all known potential customers) is first used to obtain an initial loyalty graph, which can then be analyzed to find best marketers. Subsequent campaigns may only initially target these best marketers and thus employ an active approach alone. But given that these results can vary over time, and across campaigns, a passive approach is run periodically to refresh this knowledge.

### Loyalty Graph

The relationships of a social network are usually publicly represented in the so-called social graph. Nodes in the social graph represent entities such as users and products, and edges represent the relationship between those entities, relationships such as a direct friendship, an invitation sent, any comments about the other user, and an explicit “liking” signal.

A loyalty graph puts together the social graph of consumers, along with their consumption information recorded in a loyalty program, to find valuable information about the impact of the relationships between customers in their purchasing patterns. For example, a loyalty graph enables brands to discover their best marketers, e.g., those users that generate the largest amount of revenue after promoting a product. In addition, a loyalty graph can identify both groups of “friends” (in the sense of a social network) that purchase goods in a coordinated fashion, as well as groups of friends that are unaware of their common purchasing mechanisms and preferences.

In one embodiment, a loyalty graph is created using:
1. The set of relationships of a given user, usually available through her social graph;
2. A loyalty program that (a) enables users to get rewards by promoting products among their online relationships and (b) tracks the actions of both promoters and those being invited to the promotion; and
3. User purchasing (or coupon usage) information to quantify how users' promotion activities translate into revenue.

The social graphs are able to be accessed publicly or through application program interfaces (APIs) that provide access through third party sites, such as when users log into these sites. In accordance with one embodiment, virtual loyalty card services provide the logistics for users to invite other users, as well as to track the actions performed by inviters and invitees, actions such as accessing a coupon for a promoted product. Systems in accordance with embodiments are integrated with Points of Sale (PoSs), providing collection of purchase information in real time. In this way, the system determines which promoters' actions have actually translated into real revenue.

A loyalty graph in accordance with one embodiment starts with the social graph of the user that is promoting a product/offer via her graph. The edges of the graph are successively marked as “invited,” when one user invites another user to join the promotion; as “accepted,” when a user accepts an invitation to join the promotion; as “viewed,” when a user views a product or service that is the subject of the promotion; as “distributed,” when a user accesses a coupon for the product or service; and as “validated,” when a user actually uses the coupon to purchase the product or service. Based on these actions, different graphs are generated and used, depending on the campaign used to implement the promotion. As one example, a campaign determines which initial users, through their relationships, generate actual views. Another campaign determines which initial users generate actual sales. These campaigns, and many others, provide useful information to brands, advertisers, marketers, and the like.

In one embodiment, graphs are successively pruned until they contain only the users that have purchased the product that has been promoted to them by the original user.

When a user invites another user to promote a product, a directed edge in the loyalty graph between the two users is created. The directed graph reflects a relationship between the two users in the context of the brand and the product. That is, the graph illustrates not only that the relationship exists, as illustrated by an undirected edge between the two in their social graph (in case it existed); the directed graph illustrates that a direct relationship between them has been established in a particular context. This additional state of the edge is denoted as “invited.”

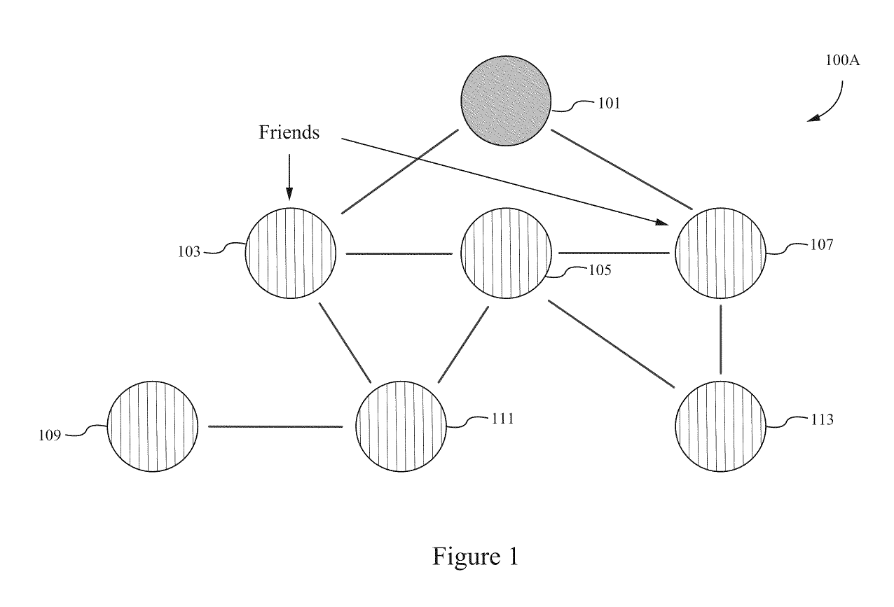

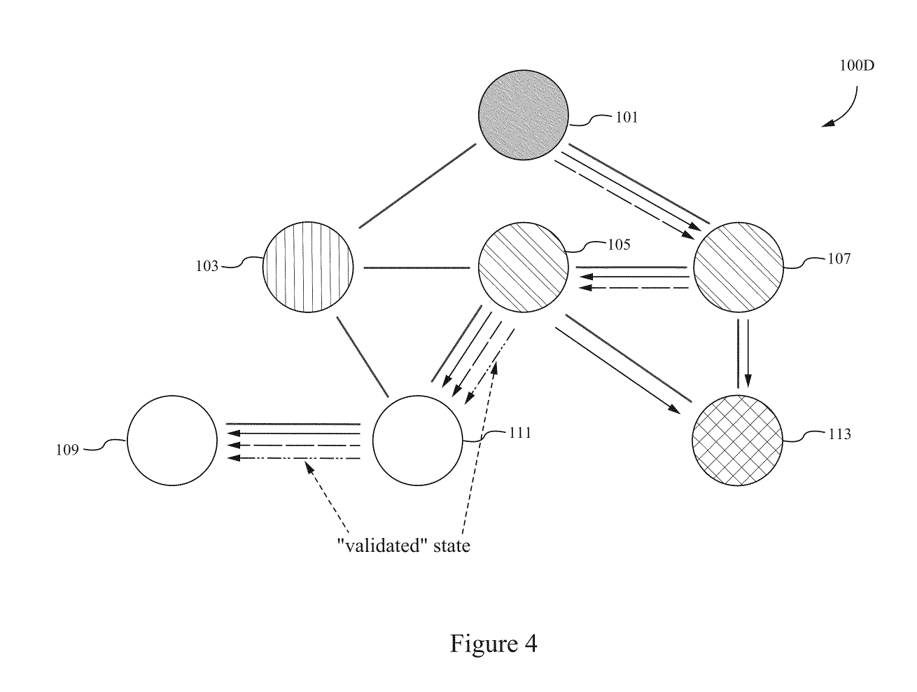

FIGS. 1-4 illustrate how loyalty graphs are generated, with FIG. 4 showing a final loyalty graph, all in accordance with the principles of the invention. FIG. 1 shows a loyalty graph 100A after a user 101 has invited users 103 and 107, both of whom also invite user 105. (The graph 100A is labeled with the suffix A to indicate that it has the same nodes as the graphs 100B-D but with the edges labeled differently.) As used in the discussion of the remaining figures, a node represents a user, and the terms “node” and “user” are used interchangeably. The users 103 and 107 both invite user 111, who in turn invites user 109. The users 105 and 107 both invite user 113. The nodes 103, 105, 107, 109, 111, and 113 are shown as vertically hatched to indicate that they represent users that have been invited to the promotion. If general, if any user is not present in a loyalty graph, a node representing the user is added, and an edge between the user and the user he invites is created. These edges, created as shown in FIG. 1, are undirected because the friendships are reciprocal relationships. If both users are new to the graph 100A, a subgraph disconnected from the main graph 100A is created. A loyalty graph can be formed by a number of disconnected subgraphs.

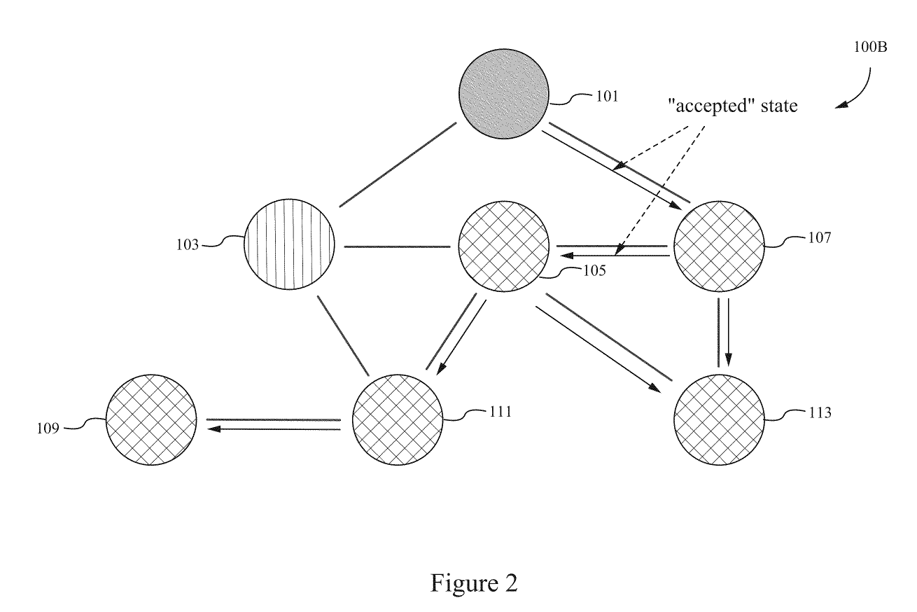

If an invitee actually visits the product, the edge in the graph 100A is marked with an additional state, denoted “accepted.” FIG. 2, for example, shows the graph 100B after the users 105, 107, 109, 111, and 113 have visited a product that is the subject of the invitation. The edges connecting the pairs of users 101 and 107, 107 and 105, 107 and 113, 105 and 111, 105 and 113, and 111 and 109 are drawn as solid lines capped by an arrow showing the direction of the relationship, identifying the edges as being in an “accepted” state. The nodes 105, 107, 109, 111, and 113 are shown as cross-hatched to indicate that have accepted or visited the product. The edges created in FIG. 2 are directed because the inviter/invitee relationship is unidirectional.

Referring to FIG. 2, because a line capped by an arrow (a “directed” line or “directed” edge) points or leads from the node 101 to the node 107, the node 101 is said to be “upstream” from the node 107, and the node 107 is said to be “downstream” to the node 101. Because directed edges lead from the node 101, to the node 107, etc., to the node 109, the node 109 is downstream to the node 101 and the node 101 is upstream from the node 109. Because the node 107 is directly coupled to the node 105, and the node 105 is directly coupled to the node 111, the edges from the node 107 to the node 105 and from the node 105 to the node 111 are said to be “adjacent” or “successive.” A path traversing directed lines is called a directed path. When traversing a directed path starting from a node, the directed path terminates in the node's “directed leaf node.”

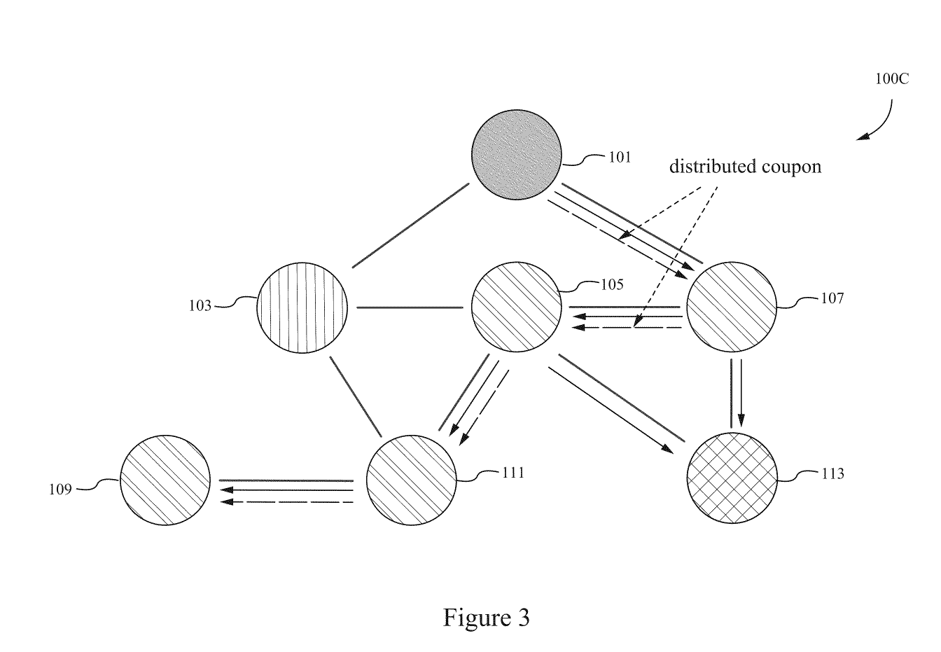

FIG. 3 shows the graph 100C after the users 105, 107, 109, and 111 have viewed the coupon, such as by printing it or by sending it by short message service (SMS), with the intention of using it. The nodes 105, 107, 109, and 111 are shown as diagonally hatched to indicate that they represent users that have viewed a coupon. The edges connecting the pair of users 101 and 107, 107 and 105, 105 and 111, and 111 and 109 are also said to be in the “distributed” state, identified as uniformly broken lines capped by an arrow.

FIG. 4 shows the graph 100D after the users 109 and 111 have actually used the coupon, such as at a point of sale (PoS). The nodes 109 and 111 are shown as un-hatched to indicate that they represent users that have used a coupon. The edges created in FIG. 4 are directed because the inviter/invitee relationship is unidirectional. The edges connecting the users 105 and 111, and 111 and 109 are thus in the “validated state,” identified by alternating segments of one long segment and two dots, capped by an arrow.

The edge states as shown in FIGS. 1-4 make the graph “inclusive,” that is, all edges present in the graphs 100B-D for a given state are also present in the graph of an earlier state. (FIGS. 1-4 progress from “earlier” states to “later” states.) For example, all edges in the “validated” loyalty graph (FIG. 4) are also present in the “distributed” loyalty graph (FIG. 3). This follows because to get into a given state, all the previous states must have been traversed.

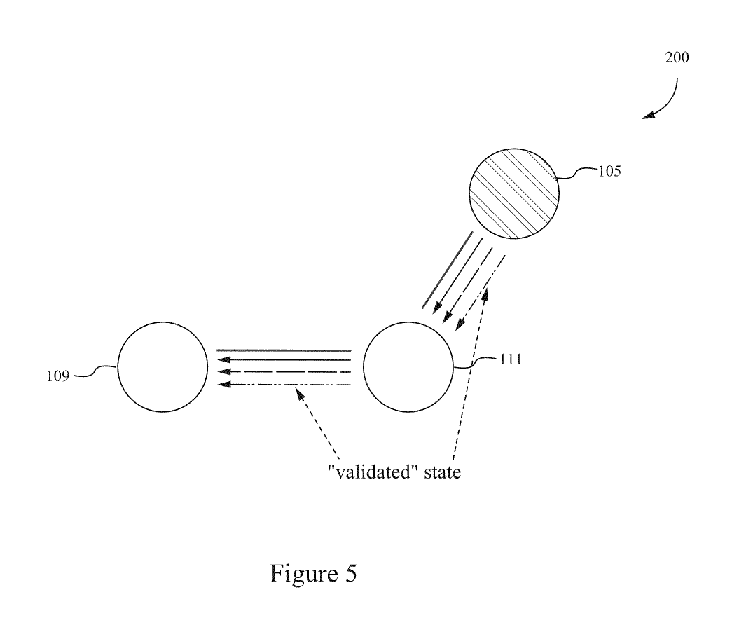

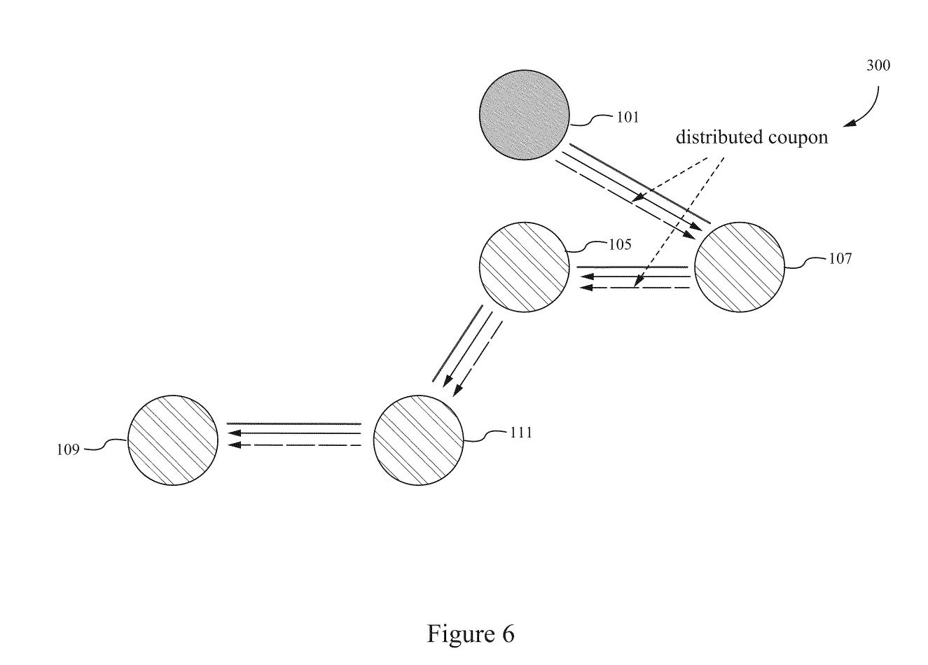

As illustrated in FIGS. 1-4, each edge in the graphs 100A-D can be marked with multiple, different states, depending on how far the invitee has gone in the product purchasing/coupon usage process. A different loyalty graph can be computed for each different state. For example, the graph 200 in FIG. 5 is similar to the graph 100D but includes only the edges of the graph 100D in a validated state. The graph 200 is considered a separate graph from the graph 100D. The graph 300 in FIG. 6 is also similar to the graph 100D but includes only the edges of the graph 100D in a distributed state. The graph 300 is also considered a separate graph from the graph 100D.

Extracting Information from a Loyalty Graph

Because each edge in a loyalty graph can be marked with multiple states, a different graph can be built for each separate state, and can thus answer different questions. For example, graphs can be used to identify groups of friends that have accessed an offer or groups of friends that have validated an offer.

However, even though finding these groups is already valuable enough for brands, it is also useful to determine for each group who are the supernodes, that is, those special users (e.g., best marketers) that have sparked accessing the offer/card within the given group of friends. This is important, because if brands want to target those groups later on for additional offers, they can do so by just targeting the supernodes, as opposed to blindly targeting all the users in the group. While targeting the group alone as opposed to the entire user base is enough to reduce spam, it is even better to target just the supernodes. In other words, finding supernodes can be very valuable if the results of a campaign can be at least the same when communicating with just a small number of supernodes, as opposed to communicating to the entire user base (e.g., sending 1,000 emails for a given campaign, as opposed to 100,000 emails). In some cases, Internet and email components identify mass mailing as spam and drop them. Reducing the amount of invitations advantageously decreases the likelihood of this happening.

Therefore, by considering only “validated” edges, the corresponding supernodes are the best marketers for a given product, that is, the best source resulting in sales. Or, by considering only “distributed” edges, the corresponding supernodes are the best promoters for a given product, that is, the best source resulting in views. In many cases both graphs provide useful information. For example, some retailers pay advertisers a certain amount for campaigns that result in views and a second, larger amount for campaigns resulting in sales. In all the cases, graphs in accordance with the principles of the invention are useful in identifying the best marketers, the best promoters, etc., by identifying the nodes in the directed graph that are the origin of the paths leading to leaf nodes. Depending on the particular promotion, the leaf nodes can represent purchases, accessing a coupon, accepting an invitation, or any other action to be monitored.

As one example, for a given offer a supernode generates a large number of visualizations and a smaller number of validations, or vice-versa. In the former case, this would indicate an opinion leader for which the offer was not interesting for his network; in the latter case, this would indicate an offer well targeted for a small group of people represented by that supernode.

### Algorithm for Determining Supernodes

In accordance with the principles of the invention, supernodes are determined by calculating a score for each of the initial nodes, that is a node in a group of users that receives a coupon or promotion and is the first to transmit it to her friend. In graph terminology, these nodes are referred to as “root” nodes. Characterized in another way, a root node has no incoming edges and, because edges indicate path traversal, a root node does not have a “previous” node. Referring to FIG. 1, the node 101 is a root node.

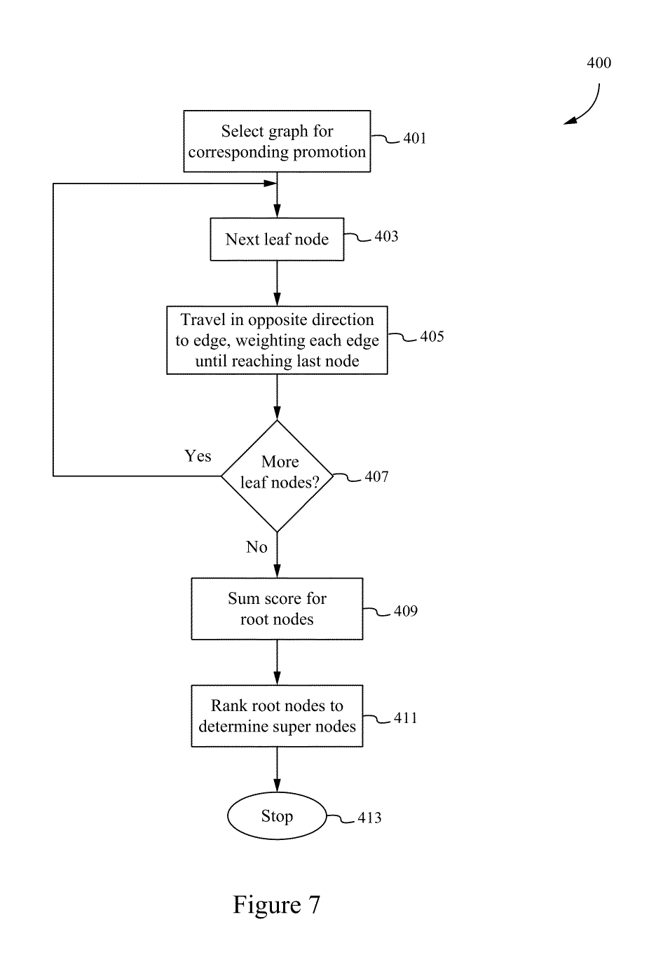

FIG. 7 shows the steps 400 of a process for determining supernodes by calculating scores in accordance with one embodiment of the invention. This process is based on what class of users are to be targeted. In the step 401, a graph for a particular promotion is selected. For example, if the campaign is to identify the “best marketers,” those supernodes that generate the largest amount of revenue, in the step 401 the loyalty graph that contains edges in a “validated state” (e.g., FIG. 5) is selected. If the campaign is to determine which supernodes are the “best inviters”, that is, the inviters with the largest number of accepted invitations, in the step 401, the loyalty graph that contains edges in “accepted state” is selected.

In the step 403, the “next” leaf node that has not yet been processed is selected. Leaf nodes are defined as those nodes that have at least one incoming edge in the state that defines that analyzed loyalty graph. In the step 405, for the next leaf node, the reverse path of the graph (that is, going in the opposite direction of the edge, that is, opposite to the direction of the arrow) is followed until there is no previous node, i.e. until the node does not have any incoming edges. As part of the traversal, a path variable Pi is maintained, which takes the value N/2̂(i-1), where N is a fixed value, and i corresponds to the number of edges traversed before arriving to a node. For example, for a leaf node, the variable P0=0. For the parent node of a leaf node, P1=N, and so on. In this embodiment, Pi=N/2̂(i-1) for i>0. Each Pi is multiplied by one or more reliability factors, if any, as described below. P0 is 0 because high scores should be assigned to inviters, not purchasers.

At each node in the path, the value of the Pi is added to a counter Cn associated with the node. In one embodiment, Cn is initialized to zero.

The value P is decreased at each step i of the path because, intuitively, the larger the distance between an inviter and an invitee, the smaller the influence the inviter has had on the invitee.

The path traversal stops when a node with no incoming edges (a “root” node) is reached.

The path traversal continues as long as there is an incoming edge, irrespective of the state of the edge. This is because the goal is to reach the original inviter. In some embodiments, loops are not allowed, while in other embodiments, they are allowed. As one example, when loops are not allowed, they can be avoided if users are not allowed to invite other users that are already part of the promotion. In a less restrictive scenario where loops are allowed, additional techniques would need to be taken into account, such as by stopping the traversal of the path if a node that has already been visited is encountered again. In still other embodiments, a general approach considers not only trees, or more generally directed acyclic graphs (DAGs), but also graphs with loops as well as undirected graphs. In these embodiments, additional algorithms are used to measure the “centrality” of nodes within these types of graphs. Centrality refers to the influence a person in a social network and can be measured in many ways. After reading this disclosure, those skilled in the art will recognize other ways to avoid loops in accordance with embodiments of the invention.

In the step 407, it is determined whether there are any more leaf nodes to process. If so, the process loops back to the step 403. Otherwise, the process continues to the step 409, where the counter or total “score” for each root node is computed.

The algorithm completes in finite time because (1) there are a finite number of leaf nodes and (2) all reverse path traversals eventually end in a node with no incoming edges, a root node.

A given node can be present in multiple paths, which means that Cn, the counter of the node, is computed as:

Cₙ=Σₖ Pₖ; Equation (1)

where each Pk corresponds to the value of the variable P of path k at node i in the path.

In the step 411, the root nodes are ranked by their values Cₙ. The root nodes with the highest scores, that is those with the highest Cn values, are selected as supernodes. As one example, those root nodes with a Cn value above a pre-determined threshold are determined to be supernodes. The threshold can be any value to suit the application at hand

In one embodiment, coupons for a new promotion are then sent to only the supernodes in a loyalty graph. In this way, fewer coupons are sent over networks connected to users, reducing network traffic and minimizing email spam, thereby reducing network congestion.

The steps 400 are merely illustrative. Other steps can be added, some can be deleted, and the steps can be performed in different orders.

The loyalty graph 100D shown in FIG. 4 is used to illustrate how the weights Cn are generated according to one example. In this example, a loyalty graph associated with the “validated” state is generated. Based on the algorithm there are five nodes participating in the loyalty graph (109, 111, 105, 107, and 101). There are two leaf nodes (109 and 111), and thus two paths path1 and path2 that start from nodes 109 and 111, respectively. Both paths end in node 101. Path1 traverses nodes 109, 111,105, 107, 101, and path2 traverses nodes 111, 105, 107, 101.

Table 1 below shows the values of the variables Pk at each node, as well as the resulting Cn value for each of the nodes.

TABLE 1

| Path | Nodes | | | | |
|---|---|---|---|---|---|
| Variables | 109 | 111 | 105 | 107 | 101 |
| P1 | 0 | N | N/2 | N/4 | N/8 |
| P2 | — | 0 | N | N/2 | N/4 |
| Cn | 0 | N | 3N/2 | 3N/4 | 3N/8 |

As one example, any node with a Cn value above a threshold value (e.g., N, where N can be an integer or a non-integer) is a supernode. When the threshold value equals N, nodes 105 and 111 are supernodes, and future promotions are sent only to them. Thus, rather than sending promotions to all 5 of the nodes (e.g., 5 coupons), only two are sent. Rather than sending coupons to only nodes 109 and 111, the actual purchasers, coupons are sent to the promoters, nodes 105 and 111, from where they will reach the actual purchasers. In promotions for similar products or services, node 111 (rather than node 109) will likely send a coupon to other likely purchasers of the similar product or service.

In accordance with some embodiments, the values Pi are weighted (e.g., multiplied by) reliability factors to better correlate actions taken by leaf nodes with the supernodes. For example, if a coupon is used soon after a user received an invitation, it is more likely that the invitation, and not some other reason, lead to the coupon usage. Conversely, the longer the time between invitation receipt and coupon usage, the less likely the invitation lead to the usage. In this example, each weight Pi along a path is multiplied by a reliability factor that reflects the confidence in the causal relationship between an invitation and coupon usage.

As some examples, if the time difference between a user receiving a coupon and the user using the coupon (ΔT) is between 0 and 7 days (between 0 and 1 week), the weighting factor (ω) equals 1. If ΔT is between 1 and 2 weeks, ω equals 0.5. If ΔT is between 2 and 3 weeks, ω equals 0.25. If ΔT is between 3 and 4 weeks, ω equals 0.125. And if ΔT is larger than 4 weeks, ω equals 0. This is just one example of a “time-based” reliability factor. Those skilled in the art with the benefit of this disclosure can determine other time-based reliability factors tailored to suit the application at hand

After reading this disclosure, those skilled in the art will recognize other reliability factors that can be used separately or combined into aggregate reliability factors. For example, multiple reliability factors can be multiplied together to weight each edge accordingly. As one example, an edge can have a time-based reliability factor of ω1 and another reliability factor of ω2. The weight of the edge will be multiplied by the product ω1*ω2.

While the examples above describe sending promotions to super users, it will be appreciated that other actions can be taken after the super users have been identified. As only a few examples, the superusers are offered jobs or have their names included on a list of “influential marketeers,” thus bringing them recognition among their peers. After reading this disclosure, those skilled in the art will recognize other actions that can be taken after identifying super users in accordance with embodiments of the invention.

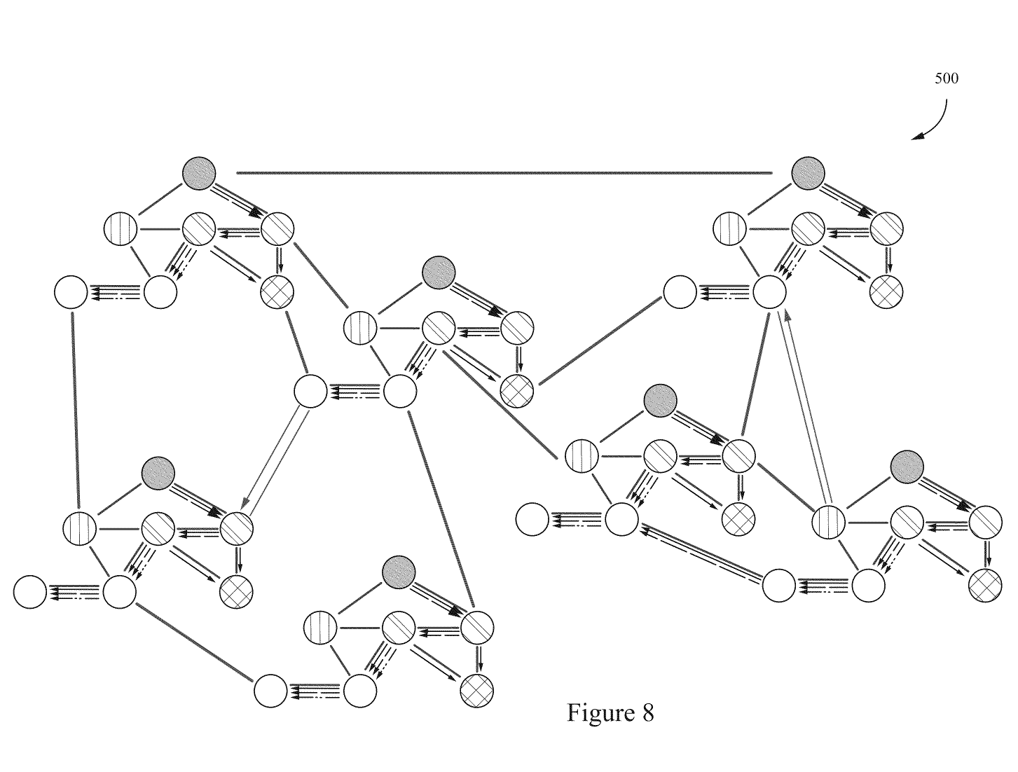

While FIGS. 1-4 show loyalty graphs 100A-D with a single root node 101, it will be appreciated that loyalty graphs generated in accordance with the invention will generally have multiple root nodes and multiple users who might be both inviters and invitees. FIG. 8, for example, shows a loyalty graph 500 generated in accordance with the invention. The loyalty graph 500 results from multiple inviters and invitees and includes multiple disjoint graphs. As in FIGS. 1-4, the solid grey nodes indicate root nodes, the vertical hatched nodes indicate invitees, the cross-hatched nodes indicate users who visit a product, and the solid white nodes indicate actual purchasers.

Disjointed graphs (subgraphs), such as those shown in FIG. 8, can be used in many different ways in accordance with the invention. For example, subgraphs can be identified in some way and selected so that promotions are transmitted to the superusers in only the selected subgraphs. As one example, a promotion is limited to a single geographic location that includes users in the selected subgraphs but not users in the non-selected subgraphs. Transmitting coupons or other promotional materials to superusers in the non-selected subgraphs would be inefficient. In this case, coupons or other promotional materials are transmitted to the superusers in only the selected subgraphs. After reading this disclosure, those skilled in the art will recognize other reasons for identifying, selecting, and using subgraphs in accordance with the principles of the invention.

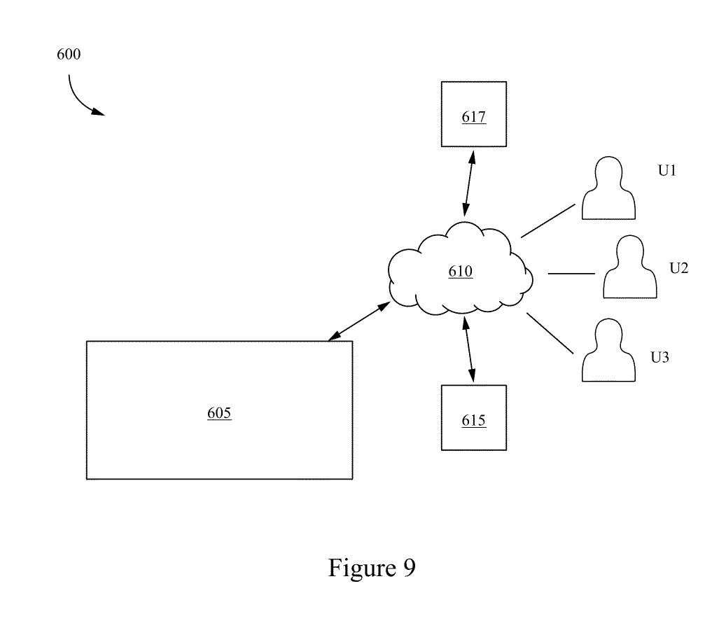

FIG. 9 is a high-level diagram used to illustrate how a loyalty graph is generated and used in accordance with one embodiment of the invention. A system 605 is coupled over the Internet 610 to multiple users U1, U2, and U3, and also to PoSs 615 and 617. The system 605 includes a memory for storing a social graph (not shown) and a processor for executing computer-executable instructions for executing the steps 400 of the process in FIG. 7. As one example, the system 605 generates a social graph when users U1, U2, and U3 “like” each other. Alternatively, the social graph is received from Facebook®, is accessed through a third party API, or accessed in some other way known to those skilled in the art. A campaign for a particular product or service is selected. Promotions, such as coupons, for the campaign are distributed from any of the users U1, U2, U3 and distributed, accessed, and used by the users U1, U2, and U3. When the coupons are distributed and accessed by users and used at points of sale 615 and 617, these actions are recognized by the system 605, which determines superusers (supernodes), such as by the steps 400. The system 605 identifies the superusers and transmits to them later promotions for the same or similar products and services. The system 605 can determine similar products and services in many ways, such as by tags generated by advertisers or other users.

In accordance with yet another embodiment of the invention, scores from multiple loyalty graphs from different promotions are combined. For example, loyalty graphs are generated for promotions related to car sales, tire sales, and vacation trips. A new promotion is started, related to car leasing. It is determined that the new promotion is closely related to the car and tire sales promotions. The Cn scores for the root nodes for the car and tire sales promotions are added and, based on a new threshold, supernodes are determined. Initial promotions are then sent to these supernodes.

Facebook's and other social graphs can be used to supplement embodiments of the invention. For example, loyalty cards and offers are made part of Facebook's social graph via its OpenGraph interface. A Facebook® social graph forms a tree with loyalty graphs generated in accordance with the invention as a root node.

In an alternative embodiment, pressing the “like” button for a card or an offer establishes an edge in the social graph between the user and the card/offer. In other words, embodiments of the invention have two dimensions, users at one level and offers and cards at another, that get connected within the social graph. Users are then connected between them in their dimension.

Additional dimensions in Facebook® that can be used in combination with embodiments of the invention, such as user comments, which have their own nodes in the social graph, referring to offers/cards in accordance with other embodiments of the invention. Some of this information is publicly available by querying Facebook's social graph and includes information such as how many comments a given offer has generated, how many people like a given card/offer, and whether there any groups of friends that like a particular card/offer. This information can be used to form a social graph that is later organized into a loyalty graph in accordance with the principles of the invention.

It will be appreciated that embodiments of the invention are able to be used with other social graphs pertaining to social networks, such as Google+graphs, to name only one such example.

It will be appreciated that the examples used for illustration are merely illustrative and can be modified in many ways in accordance with the principles of the invention. For example, once the system 605 determines superusers, this list of superusers can be transmitted to another system that transmits the promotions.

It will be readily apparent to one skilled in the art that other modifications may be made to the embodiments without departing from the spirit and scope of the invention as defined by the appended claims.

We claim:

1. A method of using a first loyalty graph having multiple nodes connected by multiple edges, each of the multiple edges assigned one or more states, the multiple nodes including leaf nodes corresponding to one of the one or more states, the method comprising:
pruning the first loyalty graph according to each of the states, thereby generating a plurality of one or more subgraphs each reflecting relationships between nodes for a given state;
for each of the one or more subgraphs, determining a weighted score for each node; and
for each of the one or more subgraphs, determining one or more supernodes as a subset of nodes having a weighted score above a first pre-determined threshold.

2. The method of claim 1, wherein the leaf nodes correspond to a user purchasing a good or service, a user having accessed a coupon for a good or service, or a user having accepted an invitation to join a group to receive a good or service or to access a good or service.

3. The method of claim 1, further comprising transmitting offers for goods or services to only the supernodes of a selected subgraph from among the multiple nodes in the selected subgraph.

4. The method of claim 1, further comprising transmitting offers for goods or services to only the nodes of selected one or more subgraphs from among the multiple nodes in the first loyalty graph.

5. The method of claim 1, further comprising identifying nodes in the first loyalty graph having edges in a same state.

6. The method of claim 1, wherein pruning the first loyalty graph comprises pruning nodes that are not supernodes.

7. The method of claim 1, wherein a weighted score for a node corresponds to a number of directed edges between the node and its one or more directed leaf nodes, a weight of each directed edge decreasing with a graphical distance between the node and its directed leaf node.

8. The method of claim 1, wherein determining a weighted score for a node comprises:
for each directed leaf node of the node, traversing a reverse path from the directed leaf node to the node, sequentially weighting each edge along the reverse path, starting with an initial weight of N, and weighting each successive edge along the path by a factor X of a weight of an adjacent downstream edge; and
summing weights of all edges directly into the node along the reverse path.

9. The method of claim 8, wherein N is an integer.

10. The method of claim 9, wherein X equals 0.5.

11. The method of claim 1, further comprising adjusting each of the weighted scores by a corresponding reliability measure.

12. The method of claim 11, wherein a reliability measure is inversely proportional to a time for a node to receive a coupon as part of the promotion and to use the coupon.

13. The method of claim 1, wherein the first loyalty graph is generated from a social graph.

14. The method of claim 1, further comprising:
combining the weighted scores with weighted scores for a second loyalty graph to determine a set of combined weighted scores; and
comparing scores in the combined set of weighted scores to a second pre-determined threshold to determine a second set of supernodes.

15. A computer-readable storage medium containing computer-executable instructions that when executed by a processor perform a method of using a loyalty graph having multiple nodes connected by multiple edges, each of the multiple edges assigned one or more states, the multiple nodes including leaf nodes corresponding to one of the one or more states, the method comprising:
pruning the loyalty graph according to each of the states, thereby generating a plurality of one or more subgraphs each reflecting relationships between nodes for a given state;
for each of the one or more subgraphs, determining a weighted score for each node; and
for each of the one or more subgraphs, determining one or more supernodes as a subset of nodes having a weighted score above a first pre-determined threshold.

16. The computer-readable storage medium of claim 15, wherein the leaf nodes correspond to a user purchasing a good or services, a user having accessed a coupon for a good or service, or a user having accepted an invitation to join a group to receive a good or service or to access a good or service.

17. The computer-readable storage medium of claim 15, wherein the method further comprises transmitting offers for goods or services to only the supernodes of a selected subgraph from among the multiple nodes in the subgraph.

18. The computer-readable storage medium of claim 15, wherein the method further comprises transmitting offers for goods or services to only the nodes of a selected one or more subgraphs from among the multiple nodes in the first loyalty graph.

19. The computer-readable storage medium of claim 15, wherein the method further comprises identifying nodes in the loyalty graph having edges in a same state.

20. The computer-readable storage medium of claim 15, wherein pruning the loyalty graph comprises pruning nodes that are not supernodes.

21. The computer-readable storage medium of claim 15, wherein the method further comprises adjusting each weighted score by a corresponding timed-based reliability factor.

22. A method of generating a graph comprising:
receiving a social graph having nodes corresponding to users and edges corresponding to relationships between the users;
scoring each of the nodes based on a predetermined action by a user downstream to the node and a distance between the node and the user downstream to the node; and
pruning from the graph those nodes with a score below a pre-determined threshold.

23. The method of claim 22, wherein the predetermined action is accepting an invitation to join a group for receiving a good or service, accessing a coupon for a good or service, or using a coupon for a good or a service.
